(19) United States
(12) Patent Application Publication
(10) Pub. No.: US 2026/0300537 A1
(43) Pub. Date: Oct. 1, 2026

(54) SECURING SENSITIVE CONTENT WHILE ON CALL WITH UNTRUSTED/UNKNOWN CALLER

(71) Applicant: MOTOROLA MOBILITY LLC, WILMINGTON, DE (US)

(72) Inventors: AMIT KUMAR AGRAWAL, BANGALORE (IN); KRISHNAN RAGHAVAN, BANGALORE (IN); NAKUL PATEL, NAGPUR (IN)

(21) Appl. No.: 19/094,951

(22) Filed: Mar. 30, 2025

(51) Int. Cl. G06F 21/62; G06F 21/32; H04M 1/57; H04M 3/42

(52) U.S. Cl. CPC G06F 21/6245; G06F 21/32; H04M 1/57; H04M 3/42059

(57) ABSTRACT

An electronic device provides various techniques for intervening during a call communication to prevent access and transfer of sensitive data of a user of the electronic device. A processor is configured to cause the electronic device to connect, via a communications subsystem, a call session with second electronic device(s). The processor monitors for a trigger to access sensitive content from the electronic device during the call session. In response to detecting the trigger to access sensitive content, the processor compares caller identification (ID) information from the at least one second electronic device to trusted caller ID information to determine whether the caller ID information is of a trusted caller. In response to determining that the caller ID information does not indicate a trusted caller, the processor performs a sensitive content intervention that at least temporarily prevents opening of or access to the sensitive content on the electronic device.

### BACKGROUND

### 1. Technical Field

The present disclosure relates generally to electronic communication devices that support person-to-person communication, and more particularly to electronic communication devices that support storage of personal/secure data.

### 2. Description of the Related Art

Electronic communication devices such as smartphones, tablets, laptops, and smart watches have evolved from primarily providing cellular communication functions. While the communication functionality continues to be a significant function of these electronic devices, the electronic devices are also provisioned with a myriad of services and functions such as office automation, communication, image/video capture, entertainment, and location services. In support of these services and functions, electronic devices increasingly secure private information of the users of respective electronic devices in order to efficiently access and use the services and functions.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1A presents a functional block diagram of example components of an electronic device in a communication environment and having hardware and software components that enable the features of the present disclosure to be advantageously implemented, according to one or more embodiments;

FIG. 1B is an additional block diagram representation of the electronic device of FIG. 1A presenting additional components, including components for wireless communications with other devices, according to one or more embodiments;

FIG. 2 is a simplified block diagram of operative components and example implementation of the electronic device with a content security during untrusted communication (CSDUC) module for detecting and intervening in disclosure of sensitive/secure information to an unknown/untrusted participant in a call session with the electronic device, according to one or more embodiments;

FIG. 3 illustrates a touch display of the electronic device presenting a call session interface that presents warnings and a second factor authentication when a second party request or a user action is detected to access or share sensitive content to an unknown/untrusted second party, according to one or more embodiments;

FIG. 4 is a flow diagram presenting a computer-implemented method for detecting and intervening in a disclosure of sensitive/secure information to an unknown/untrusted participant during a call session with the electronic device, according to one or more embodiments; and

FIGS. 5A – 5B (collectively “FIG. 5”) is a flow diagram presenting a second computer-implemented method for intervening during a communication call via the electronic device with a second electronic device that is unknown or untrusted, according to one or more embodiments.

### DETAILED DESCRIPTION

According to aspects of the present disclosure, an electronic device, a method, and a computer program product provide various techniques for intervening during a communication session with a second electronic device to prevent access and transfer of sensitive data of a user of the electronic device to a second unknown/untrusted/unvetted user of the second electronic device. In today's fast-paced world, audio and video calls continue to be a common method for communication between two or more people who are at different locations. In some instances, a user of the electronic device may not be sufficiently cognizant of the risk of inadvertently or impulsively sharing sensitive information with other participants to the call. The other participant may be unknown or is otherwise not a trusted participant. Malevolent operations have been used to pray upon people with a ruse designed to obtain sensitive information such as financial account access information, personal identifiable information for identity theft, and private data that can be used for blackmail or theft. In an example, when users receive calls from untrusted numbers, fraudsters increasingly exploit naivete of the users by posing as legitimate entities and tricking these individuals into divulging their private information.

When users receive calls from unknown numbers with trained scam operatives, the user may be tricked into and/or feel compelled to share sensitive details, such as credit card numbers, passwords, or social security numbers, without fully considering the risks involved. Additionally, user electronic devices are increasingly being uses as a secure repository for the user’s sensitive information. For efficiency and convenience, the user electronic device provides intuitive interface features and functions that enable a user to quickly access and use the sensitive information. In addition to the sensitive information that a user can remember, the vulnerability to inadvertent disclosure is exacerbated by the ease of access to secure content on the user’s electronic devices during calls, which can lead to hasty decisions. Therefore, there is an urgent need for a solution that protects users from inadvertent disclosure due to scams and identity theft perpetrated over calls made to the user device, particularly when the user is engaging with unknown/untrusted callers.

According to one or more embodiments, an electronic device has a memory that includes a content security during untrusted communication (CSDUC) module. The electronic device includes a communications subsystem that links the electronic device to a communication network. A processor of the electronic device is communicatively coupled to the memory and the communications subsystem. The processor is configured to cause the electronic device to connect, via the communications subsystem, a call session with at least one second electronic device. The processor is further configured to cause the electronic device to monitor for a trigger to access sensitive content from the electronic device during the call session. In response to detecting the trigger to access sensitive content, the processor is configured to cause the electronic device to compare caller identification (ID) information from the at least one second electronic device to trusted caller ID information to determine whether the caller ID information is a caller ID that is of a trusted caller. In response to determining that the caller ID information does not indicate that the at least one second electronic device is of a trusted caller, the processor is further configured to cause the electronic device to perform a sensitive content intervention that at least temporarily prevents opening of or access to the sensitive content on the electronic device.

According to one or more embodiments, a method is provided for detecting and intervening in a disclosure of sensitive/secure information to an unknown/untrusted participant in a call session with the electronic device. The method includes connecting, via an electronic device, a call session with at least one second electronic device. In an example, the second electronic device initiates the call session. In another example, the user of the electronic device responds to a previous attempt by the second electronic device to start a communication session. In an additional example, the user responds to a call number for the second electronic device provided in a website, an advertisement, text message, email or other content. The method includes monitoring for a trigger to access or provide sensitive content from the electronic device or the user during the call session. In response to detecting the trigger to access or provide sensitive content, the method includes comparing caller identification (ID) information from the at least one second electronic device to trusted caller ID information to determine whether the caller ID information comprises a caller ID that is of a trusted caller. In response to determining that the caller ID information does not indicate that the at least one second electronic device is of a trusted caller, the processor is further configured to cause the electronic device to perform a sensitive content intervention that at least temporarily prevents opening of or access to or transfer of the sensitive content on/from the electronic device.

According to one or more embodiments, a computer-implemented method is provided for intervening during a communication call via the electronic device with a second electronic device that is unknown or untrusted. The intervention is directed toward preventing access and transfer of sensitive data of a user of the electronic device to a second user of the second electronic device.

Further embodiments provide a computer program product that includes: a non-transitory computer readable medium; and program code on the computer readable medium that, when processed by a processor of an electronic system, configures the processor and/or the electronic system to perform functions of the above-described method.

The above contains simplifications, generalizations and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with skill in the art upon examination of the figures and the remaining detailed written description. The above as well as additional objectives, features, and advantages of the present disclosure will become apparent within the following detailed description.

In the following description, specific example embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized, and that logical, architectural, programmatic, mechanical, electrical and other changes may be made without departing from the general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various aspects are described which may be aspects for some embodiments but not other embodiments.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc., do not denote any order or importance, but rather the terms first, second, etc. are used to distinguish one element from another.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be provided its broadest interpretation given the context in which that term is utilized.

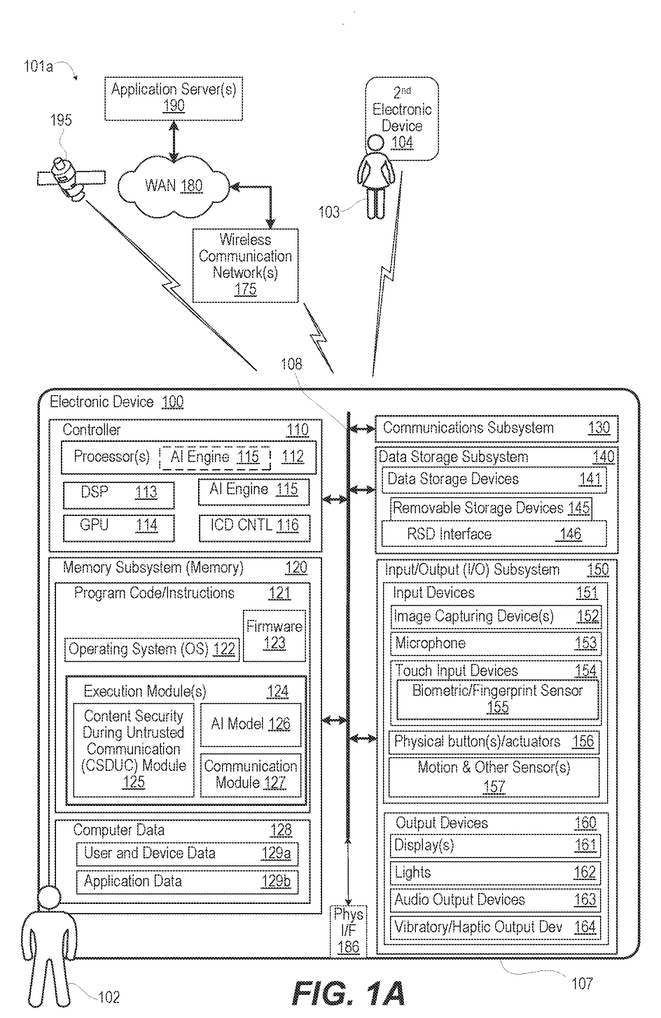

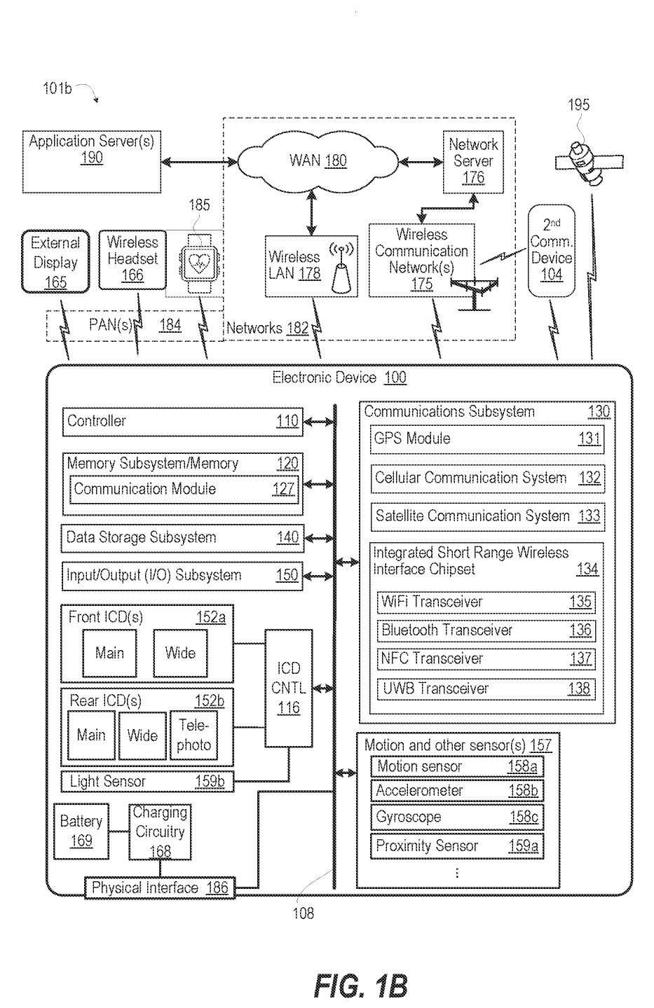

Those of ordinary skill in the art will appreciate that the hardware components and basic configuration depicted in the following figures may vary. For example, the illustrative components within electronic device 100 (FIG. 1A – 1B) are not intended to be exhaustive, but rather are representative to highlight components that can be utilized to implement the present disclosure. For example, other devices/components may be used in addition to, or in place of, the hardware depicted. The depicted example is not meant to imply architectural or other limitations with respect to the presently described embodiments and/or the general disclosure.

Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural, functional, operational, or otherwise) on the described embodiments.

Referring now to the figures and beginning with FIG. 1A, there is illustrated a block diagram of an example electronic device 100 in communication environment 101 a and having hardware and software components, which enable the features of the present disclosure to be advantageously implemented, according to one or more embodiments. Examples of electronic device 100 can include, but are not limited to, mobile devices, a notebook computer, vehicle-integrated communication system, a mobile phone, a smart phone, a digital camera with enhanced processing capabilities, a smart watch, a tablet computer, a heads up display (e.g., smart glasses) worn by user 102, and other types of electronic devices. For purposes of this disclosure, electronic device is assumed to be a communication device that can be used to communicate with second user(s) 103 who use corresponding second electronic device(s) 104. Electronic device 100 can therefore be interchangeably referred to herein as a communication device.

Electronic device 100 generally includes controller 110, memory (or memory subsystem) 120, communication subsystem 130, data storage subsystem 140, input/output subsystem 150, all contained within or extended from an exterior surface of device housing 107. Controller 110 is shown communicatively connected/coupled via system interlink 108 with each of the subsystems 120, 130, 140, and 150, and is directly or indirectly connected with the individual components within each subsystem 120, 130, 140, and 150. System interlink 108 represents internal components that facilitate internal communication by way of one or more shared or dedicated internal communication links, such as internal serial or parallel buses. As utilized herein, the term “communicatively coupled” means that information signals are transmissible through various interconnections, including wired and/or wireless links, between the components. The interconnections between the components can be direct interconnections that include conductive transmission media or may be indirect interconnections that include one or more intermediate electrical components.

Controller 110 includes processor 112, which includes one or more central processing units (CPUs) or data processors. Processor 112 performs many of the features of controller 110 and references to features performed by controller 110 can be interchangeably referred to herein as features of processor 112, and vice versa. In some embodiments, the various functions associated with controller 110 are integrated into processor 112, and accordingly, references made herein to controller and/or processor are understood to refer to one or both components as providing a single management component within the electronic device 100. For simplicity in describing the features of the electronic device 100, the operational functions provided by one or more operational components within controller 110, including those provided by processor 112 are collectively described as being performed by controller 110. Collectively, components integrated within controller 110 support computing, classifying, processing, transmitting and receiving of data and information, and presenting of graphical and photographic images within a display.

As illustrated, controller 110 can also include one or more digital signal processors 113, graphics processing units (GPUs) 114, artificial intelligence (AI) engine 115, and image capturing device (ICD) controller 116. In some embodiments, the functionality of each of these additional processing components can be integrated with processor(s) 112. For example, processor 112 can, in some embodiments, include dedicated AI engine 115 and image signal processors (ISPs) (not shown). Processor 112 can further include other processors such as auxiliary processor(s) that may act as a low power consumption, always-on sensor hub for physical sensors.

Controller 110 manages, and in some instances directly controls, the various functions and/or operations of electronic device 100. These functions and/or operations include, but are not limited to including, application data processing, communication, location and navigation tasks, image processing, and signal processing. In one or more alternate embodiments, electronic device 100 may use hardware component equivalents for application data processing and signal processing. For example, electronic device 100 may use special purpose hardware, dedicated processors, general purpose computers, microprocessor-based computers, micro-controllers, optical computers, analog computers, dedicated processors and/or dedicated hard-wired logic. Controller 110 can, in some embodiments, also include a hardware acceleration (HA) unit, which can establish direct memory access (DMA) sessions to route network traffic to various elements within electronic device 100 without direct involvement from processor 112 and/or a device operating system 122 .

Memory subsystem (or memory) 120 may include a combination of volatile and non-volatile memory, such as random-access memory (RAM) and read-only memory (ROM). Memory subsystem 120 stores instruction or program code 121 for execution by processor 112 to configure processor 112 (and more generally electronic device 100) to provide the operational functions and features described herein. Instructions/program code 121 (or program code 121 for short) includes instructions for an operating system (OS) 122, firmware 123, such as basic input/output system (BIOS) or Uniform Extensible Firmware Interface (UEFI). Program code 121 includes execution module(s) 124 that collectively provides the various features of the disclosure. Execution module(s) 124 include, without limitation, CSDUC module 125, which provides the features and operating functionality of the disclosed embodiments when the corresponding program instructions of CSDUC module 125 are processed by/within processor 112/controller 110.

Execution modules 124 further includes AI model(s) 126. In one or more embodiments, processor 112 can utilize AI models 126 to provide AI functionality of processor-integrated AI engines 115. In other embodiments, AI models 126 are directly utilized by AI engine 115. In one or more embodiments, AI model 126 is integrated as a sub-module within CSDUC module 125 and is trained to support the AI features of CSDUC module 125. AI model(s) 126 may include an artificial neural network, a decision tree, a support vector machine, Hidden Markov model, linear regression, logistic regression, Bayesian networks, and so forth. AI model(s) 126 can be individually trained to perform specific tasks and can be arranged in different sets of AI models to generate different types of output. Training of AI model(s) 126 is the process by which AI models are trained to perform specific tasks or achieve certain objectives. The training involves providing the model with a large amount of data and allowing the model to learn from patterns and relationships within that data.

Each of the above-introduced module(s) and/or application(s) provides program instructions/code that are processed by processor 112 and which configures processor 112 (and/or controller 110) and/or other operational components of electronic device 100 to cause the electronic device 100 to perform specific operations and functions, as described herein. Descriptive names assigned to these modules add no functionality and are provided solely to assist in identifying the underlying features performed by processing the different modules. For example, CSDUC module 125 can include program instructions for intervening during a call session to prevent disclosure of sensitive content by a user of electronic device 100 to an unknown or untrusted caller. The instructions may provide for the intervention including a warning message presented via output device 160. The intervention may include a required second factor authentication before access or transmission of sensitive content is allowed. The program instructions of CSDUC module 125, when executed, may configure electronic device 100 to anticipate the impending disclosure by detecting trigger statements made by the unknown/untrusted caller that could prompt user 102 to respond with sensitive content known to user 102 and prevent the disclosure. The program instructions of CSDUC module 125, when executed, may configure electronic device 100 to store and allow use of sensitive content with intervention triggered during the call by attempts by user 102 to access/use the sensitive content that risks disclosure to the unknown/untrusted caller.

Program code 121 can further include instructions/code for other applications (not shown) providing different features of/within electronic device 100. In one or more embodiments, program code 121 may be integrated into a distinct chipset or hardware module as firmware that operates separately from other executable program code. Portions of program code 121 may be incorporated into different hardware components that operate in a distributed or collaborative manner.

Memory subsystem 120 also includes computer data 128. During execution of program code 121, processor 112 may access, use, generate, modify, store, or communicate computer data 128, such as user and device data 129a and application data 129b. Computer data 128 may incorporate “data” that originated as raw, real-world “analog” information that consists of basic facts and figures. Computer data 128 includes different forms of data, such as numerical data, images, coding, notes, and financial data, as well as data presenting video, graphics, text, and images. Computer data 128 may originate at electronic device 100 or may be retrieved from a remote device via communications subsystem 130. Electronic device 100 may store, modify, present, or transmit computer data 128.

Communications subsystem 130 includes various components that enable electronic device 100 to communicate with external communication networks and other devices, such as second electronic device 104 and application server(s) 190, etc., via communications subsystem 130. According to one or more embodiments, communication module 127 presented within program code 121 includes instructions supporting the use of communications subsystem 130 to establish communication interfaces enabling communication by electronic device 100 with these external networks and devices.

Data storage subsystem 140 of electronic device 100 includes data storage device(s) 141. Controller 110 is communicatively connected, via system interlink 108, to data storage device(s) 141. Data storage subsystem 140 provides stored versions of program code 121 and computer data 128 on nonvolatile storage that is accessible by controller 110. The program code 121 can be loaded into memory 120 for execution/processing by controller 110. In one or more embodiments, data storage device(s) 141 can include hard disk drives (HDDs), optical disk drives, and/or solid-state drives (SSDs), etc.

Data storage subsystem 140 of electronic device 100 can include removable storage device(s) (RSD(s)) 145, which is received in RSD interface 146. Controller 110 is communicatively connected to RSD 145, via system interlink 108 through RSD interface 146. In one or more embodiments, RSD 145 is a non-transitory computer program product or computer readable storage device that stores program code and associated data, including a copy of CSDUC module 125 and AI model(s) 126, which may be executed by a processor associated with a user device, such as electronic device 100. Controller 110 can access data storage device(s) 141 or RSD(s) 145 to provision electronic device 100 with stored program code 121 and computer data 128 that, when executed/processed by processor 112, the program code configures processor 112 and/or more generally electronic device 100, to provide the various functions described herein.

I/O subsystem 150 includes input devices 151 such as, but not limited to, image capturing device(s) (ICDs) 152, microphone 153, and touch input devices 154 (e.g., touch screens, keys, or buttons) for use by user 102 to interface with electronic device 100. Touch input devices 154 can include a biometric/fingerprint sensor 155 for biometric input. Biometric/fingerprint sensor 155 can be used to read/receive biometric data, such as fingerprints, to identify or authenticate a user. In some embodiments, the biometric sensor 155 can supplement an ICD (camera), which captures images for user detection/identification via facial recognition.

Input devices 151 may include physical buttons/actuators 156 that can be located on a periphery of the device housing 107. Physical buttons/actuators 156 may provide controls for volume, power, and ICDs 152. Microphone 153 can also be referred to as an audio input device. In some embodiments, microphone 153 may be used for identifying a user via voiceprint, voice recognition, and/or other suitable techniques. Input devices 151 can also include one or more motion or other sensor(s) 157, which are further defined in the FIG. 1B description which.

With reference to FIG. 1B, as illustrated, motion and other sensor(s) 157 of electronic device 100 include, but are not limited to, one or more motion sensor(s) 158a, one or more accelerometers 158b, one or more gyroscopes 158c, and proximity sensor 159a, etc. Motion sensor(s) 158a detects movement of electronic device 100 and provides motion data to processor 112 indicating the spatial orientation, position and movement of electronic device 100. Accelerometers 158b measure linear acceleration of movement of electronic device 100 in multiple axes (X, Y and Z). For example, accelerometers 158b can include three accelerometers, where one accelerometer measures linear acceleration in the X axis, one accelerometer measures linear acceleration in the Y axis, and one accelerometer measures linear acceleration in the Z axis. Accelerometers 158b can be used to calculate the orientation/position of electronic device 100 relative to the earth and can also be referred to as a gravity sensor. Gyroscope 158c measures rotation or angular rotational velocity of electronic device 100. Proximity sensor 159a senses the presence of nearby objects. In one embodiment, proximity sensor 159a can be an infrared (IR) sensor that detects the presence of a nearby object, such as when electronic device 100 is in a pocket of a user. Electronic device 100 can also include one or more light sensors 159b, which detects the luminance and/or intensity (i.e., the amount) of ambient light surrounding the electronic device 100.

Referring again to FIG. 1A, I/O subsystem 150 includes output devices 160 such as, but not limited to, display(s) 161, lights 162, audio output devices 163, and vibratory and/or haptic output devices 164. In one or more embodiments, electronic device 100 includes an integrated display 161 which incorporates a tactile, touch screen interface that can receive user’s tactile/touch input. As a touch screen device, integrated display 161 allows a user to provide input to and/or to control electronic device 100 by touching features within a user interface presented on integrated display 161. Tactile, touch screen interface (e.g., touch input device 154) can be utilized as an input device. The touch screen interface (154) can include one or more virtual buttons or selectable affordances. In one or more embodiments, when a user applies a finger or stylus on the touch screen interface (154) in the region demarked by the virtual button, the touch of the region causes the processor 112 to execute code to implement a function associated with the virtual button. In some implementations, integrated display 161 is integrated into a front surface of electronic device housing 107 along with front image capturing devices (not specifically shown), while the higher quality ICDs are located on a rear surface of device housing 107. Other embodiments provide multiple integrated displays within electronic device 100 and references to display(s) 161 are assumed to refer to one or all of these multiple integrated displays.

Vibration/haptic output device 164 can cause electronic device 100 to vibrate or shake when activated. Vibration/haptic output device 164 can be activated during an incoming call or message in order to provide an alert or notification to a user of electronic device 100. In one or more embodiments, integrated display 161, audio output devices (or speakers) 163, and vibration/haptic device 164 can generally and collectively be referred to as output devices.

With reference again to FIG. 1B and with continuing reference to FIG. 1A, there is presented another view of electronic device 100 with components enabling electronic device 100 to function as a mobile communication device, within an expanded communication environment 101b. In addition to the functional and operational components already presented by and described within the description of FIG. 1A, FIG. 1B further illustrates expanded communications subsystem 130 with additional communication components and interfaces enabling electronic device 100 to perform wireless communications within an expanded communication environment 101b that includes other devices.

Communications subsystem 130 includes global positioning system (GPS) module 131 that enables electronic device to communicate with and receive GPS location data from GPS satellite(s) 195. In one or more embodiments, GPS module 131 receives geospatial input from GPS broadcasts of time data and location data from GPS satellite(s) 195 to obtain geospatial location information about the physical location of electronic device 100.

In one or more embodiments, controller 110, via communications subsystem 130, performs multiple types of cellular over-the-air (OTA) or non-cellular wireless communication, such as by using a Bluetooth connection or other personal access network (PAN) connection. As shown, communications subsystem includes cellular communication system 132, which includes at least one radio frequency RF front end coupled to one or more antennas. In one or more embodiments, cellular communication system 132 can include a communication module with one or more baseband processors or digital signal processors, one or more modems, and a radio frequency (RF) front end having one or more transmitters and one or more receivers. In one or more embodiments, controller 110, via communications subsystem 130, may communicate via an OTA cellular connection with radio access networks (RANs) over a cellular wireless communication network (CWCN) 175. CWCN 175 can be a terrestrial network and include a plurality of base stations and associated network server(s) 176, in one embodiment. Cellular communication system 132 allows electronic device 100 to communicate wirelessly with CWCN 175 via transmissions of communication signals (represented as lightning bolts) to and from network communication devices, such as base stations or cellular nodes, of CWCN 175. Alternatively, or in addition, CWCN 175 can include a satellite network, and electronic device 100 connects to CWCN 175 using satellite communication system 133. Cellular communication system 132 and satellite communication system 133 enable electronic device 100 to engage in long distance wireless communication capabilities.

In one or more embodiments, communications subsystem 130 includes integrated short range wireless interface chipset 134 having one or more of Wi-Fi transceiver (TxRX) 135, Bluetooth (BT) TxRx 136, near field communication (NFC) transceiver 137, and ultra-wideband (UWB) transceiver 138. In one or more embodiments, the short-range communication devices are not integrated on a single chipset but can be separately provided hardware components. In one or more embodiments, electronic device 100 can communicate wirelessly with external wireless devices, such as a Wi-Fi router of a wireless local area network (WLAN) 178 and/or second electronic device 104, via one or more short-range wireless interface(s). Second electronic device 10 4 can be a communication device, such as a smartphone, and/or can be similarly configured as electronic device 100. Second user 103 may operate second electronic device 10 4. In one or more embodiments, electronic device 100 can receive Internet or Wi-Fi based calls, text messages, multimedia messages, and other notifications via a combination of wireless and wired networks (generally networks 182).

In one or more embodiments, networks 182 can include CWCN 175, WLAN 178, and Wide Area Network (WAN) 180, such as the Internet. In one or more embodiments, WAN 180 can enable electronic device 100 to access application servers 190, which can provide a downloadable version of CSDUC module 125 and/or access to other applications, online transactions, and resources.

In one or more embodiments, networks 182 can also include personal area networks (PAN) 184, which are individually created with second devices via one of short-range wireless devices from among Wi-Fi TxRX 135, BT TxRx 136, NFC transceiver 137, and UWB transceiver 138. Example second devices include external display 165, wireless headset 166, and wearable computing device 185. External display 165 can be a stand-alone monitor/display or a display integrated into a second electronic device, such as a laptop computer. In at least one embodiment, connection to the external display 165 can be wired and can include an intermediate connection device, such as a docking station device. In one or more embodiments, wearable computing device 185, such as a smartwatch, fitness tracker, or the like, may be paired with electronic device 100, and provide biometric data such as heart rate, breathing rate, and the like, to the electronic device 100 via the paired communication link.

Electronic device 100 also includes a physical interface 186. Physical interface 186 of electronic device 100 can serve as an input/output data port and can be used as a power supply port that is coupled to charging circuitry 168 which feeds electrical power to device battery 169 to enable recharging of device battery 169 and/or powering of electronic device 100. As a data port, physical interface 186 can enable electronic device 100 to be physically coupled via a cable or docking station port to a second device, such as external display 165.

FIG. 1B also presents additional details of ICD(s) 152 of electronic device 100. Throughout the disclosure, the term image capturing device (ICD) is synonymous with and/or utilized interchangeably with any one of the cameras of electronic device 100. ICD(s) (or cameras) 152 includes front cameras 152a and rear cameras 152b. In one embodiment, each of front cameras 152a and rear cameras 152b are communicatively coupled to ICD controller 116. ICD controller 116 supports the processing of image data from front cameras 152a and rear cameras 152b. Front cameras 152a can include a main camera and a wide-angle camera. Rear ICDs cameras 152b can include a main camera, a wide-angle camera, and a telephoto camera. Both sets of cameras 152 include image sensors that can capture images that are within the field of view (FOV) of each respective camera 152. In one or more embodiments, one or more of the cameras can be utilized to enable biometric authentication using facial image and/or iris scan recognition.

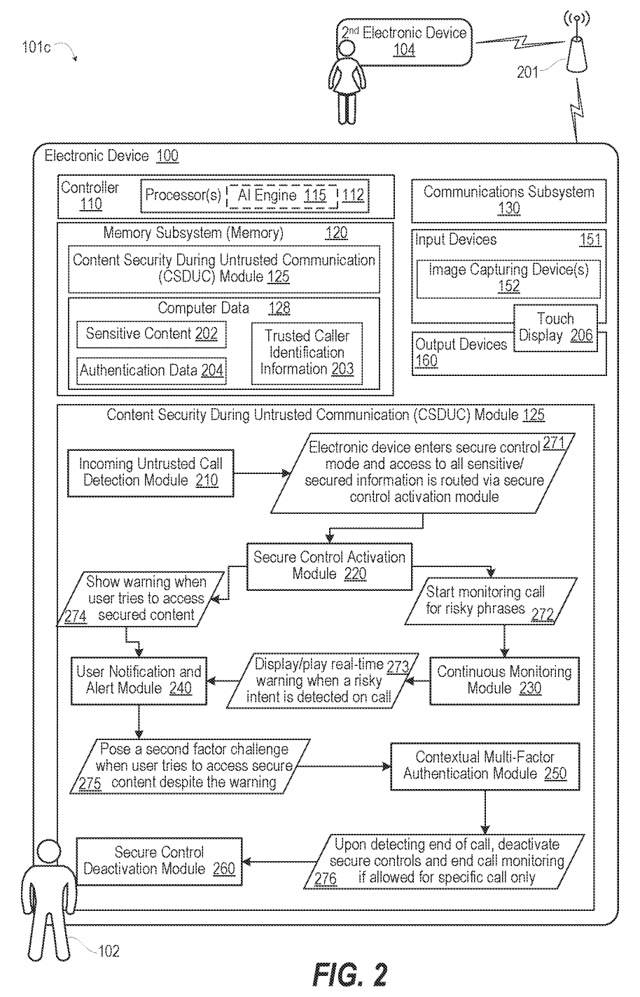

FIG. 2 is a simplified block diagram of operative components within an example implementation of electronic device 100 conducting a call session with at least one second electronic device 104 via communication network 201 in communication environment 101c. Communication environment 101c may include some or all of the features, functions and devices as described with regard to communication environment 101a (FIG. 1A) and communication environment 101b (FIG. 1B). In an example, electronic device 100 includes controller 110 having processor(s) 112 with AI engine 115. Memory 120 includes CSDUC module 125 for detecting and intervening in an ill-advised disclosure of sensitive/secure information (e.g., sensitive content 202) to an unknown/untrusted participant (e.g., second user 103) in a call session with electronic device 100. Memory 120 includes trusted caller identification information 203 for identifying known trusted callers. Computer data 128 in memory also includes authentication data 204 that is used by CSDUC module 125. In an example, user 102 interacts with functions provided by CSDUC module 125 via input devices 151 (e.g., image capturing device 152) and output devices 160 (e.g., touch display 206). Electronic device 100 communicates with second electronic device 104 via communications subsystem 130.

In one or more embodiments, CSDUC module 125 includes incoming untrusted call detection module 210, secure control activation module 220, continuous monitoring module 230, user notification module 240, contextual multi-factor authentication module 250, and secure control deactivation module 260. In an example, incoming untrusted call detection module 210 triggers first operation 271 where electronic device 100 enters a secure control mode and access to all sensitive/secured information (e.g., sensitive content 202) is routed via secure control activation module 220. Secure control activation module 220 performs second operation 272 where continuous monitoring module 230 starts monitoring the call for trigger phrases associated with soliciting sensitive content 202 either stored on electronic device 100 or known by user 102. Continuous monitoring module 230 responds with third operation 273 involving display/play of a real-time warning, via user alert notification and alert module 240 when a trigger phrase is detected during the call indicating a malicious or exploitive intent of second user 103. Secure control activation module 220 also may perform fourth operation 274 where user notification and alert module 240 is prompted to show a warning when user 102 tries to access secured content (e.g., sensitive content 202 stored or accessible to electronic device 100). User notification and alert module 240 responds by performing fifth operation 275 where electronic device 100 poses a second factor challenge when user 102 tries to access secure content despite a warning. Contextual multi-factor authentication module 250 monitors for successful authentication to enable the access to the secure content. Secure control deactivation module 260 performs sixth operation 276 that, upon detecting an end of the call, deactivates secure controls to secured content and ends call monitoring, if call monitoring is allowed for specific calls (e.g., untrusted callers).

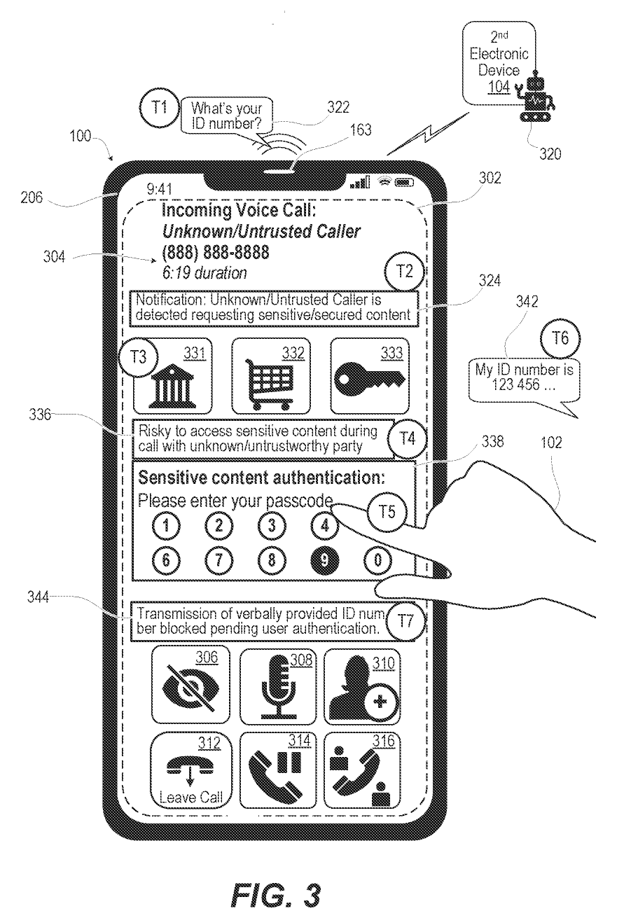

FIG. 3 illustrates touch display 206 of electronic device 100 presenting call session interface 302 that presents a warning and a second factor authentication when a second party request or a user action is detected to access or share sensitive content to an unknown/untrusted second party to an ongoing call. Call session interface 302 includes identification information 304 for second user(s)/second electronic device(s). Call session interface 302 includes call controls such as: (i) camera toggle control 306; (ii) microphone toggle control 308; (iii) add second electronic device control 310; (iv) leave call control 312; (v) hold call control 314; and (vi) transfer call control 316. In an example, the call session is with second electronic device 104 that is being used by a person (e.g., second user 103 of FIG. 1A) or by automated second party 320 such as an artificial intelligence (AI) agent having natural language processing (NLP) functionality. Identification information 304 provided by second electronic device 104 may not be recognized by electronic device (i.e., unknown). Alternatively, identification information 304 may be identified as a known untrustworthy party. The identification may be based on cloud-sourced reports or network-based tracking of past malicious activities. A sensitive content intervention to prevent disclosure of sensitive information may be enabled for all calls. Alternatively, the sensitive content intervention may be enabled in response to detecting an unknown caller or an untrustworthy caller. At a first time “T1”, trigger phrase 322 (e.g., “what is your ID number?”) is received from second electronic device 104 and presented via audio output device 163. In response, at a second time “T2” electronic device presents first warning message 324 (e.g., notification: unknown/untrusted caller is detected requesting sensitive/secured content”). First warning message 324 reminds user 102 not to speak or type sensitive information that the user remembers.

Alternatively, or in addition, electronic device 100 may provide sensitive content intervention for sensitive information that is stored at or accessible to electronic device 100. Controls 331, 332 and 333 are respectively financial transaction, purchase transaction, and password/encryption storage examples of affordances presented by touch display 206. At third time “T3”, user 102 may activate one of controls 331, 332 and 333 to initiate access or use of secured sensitive content or information. In response, at fourth time “T4”, electronic device 100 may present second warning message 336 (e.g., “risky to access sensitive content during call with unknown/untrustworthy party”). Alternatively, or in addition, at fifth time “T5” electronic device 100 may present second factor authentication interface 338 to enable access to or use of controls 331, 332 and 333. The requirement to input authentication emphasizes to user 102 the risks of the pending disclosure. In addition, authentication may prevent disclosure if another person (i.e., not the authorized device user) has gained access to electronic device 100 when/while the device is unlocked.

In one or more embodiments, AI engine 115 (FIG. 1A) of electronic device 100 may include NLP functionality to not only detect received phrases 322 but also to detect input of sensitive information by user 102 and to respond by preventing transmission to second electronic device 104. In an example, at sixth time “T6”, user makes a verbal statement 342 (e.g., my ID number is 123 456 …”) At seventh time “T7”, electronic device 100 recognizes that the user intends to disclose sensitive content and may block transmission of statement and present warning 344 (e.g., transmission of verbally provided ID number blocked pending user authentication”). Electronic device 100 requires another second factor authentication such as second factor authentication interface 338.

According to aspects of the present disclosure and with particular reference to FIG. 2, electronic device 100 has memory 120 that includes content security during untrusted communication (CSDUC) module 125. Electronic device 100 includes communications subsystem 130 that links electronic device to communication network 201. Processor 112 of controller 110 is communicatively coupled to memory 120 and communications subsystem 130. Processor 112 is configured to cause electronic device 100 to connect, via communications subsystem 130, a call session with at least one second electronic device 104. In an example, second electronic device 104 initiates the call session. In another example, user 102 of electronic device 100 responds to a previous attempt (e.g., missed call entry or voicemail) by second electronic device 104 to start a communication session. In an additional example, user 102 responds to a call number for second electronic device 104 provided in a website, an advertisement, text message, email or other content. Processor 112 is further configured to cause electronic device 100 to monitor for a trigger to access sensitive content from electronic device 100 during the call session. In an example, the trigger may be a request to provide personal identifiable information (PII) that could be used for identity theft. In another example, the trigger may be a request for financial account numbers, usernames, passwords, security questions, that enable digital theft. In response to detecting the trigger to access sensitive content, processor 112 is further configured to cause electronic device 100 to compare caller identification (ID) information 304 (FIG. 3) from at least one second electronic device 104 to trusted caller ID information 203 to determine whether caller ID information 304 (FIG. 3) is a caller ID that is of a trusted caller. In response to determining that caller ID information 304 (FIG. 3) does not indicate that at least one second electronic device 104 is of a trusted caller, processor 112 is further configured to cause electronic device 100 to perform a sensitive content intervention that at least temporarily prevents opening of or access to sensitive content 202 on electronic device 100.

In one or more embodiments, electronic device 100 includes at least one output device 160 communicatively coupled to processor 112. Processor 112 is further configured to cause electronic device 100 to perform the sensitive content intervention by presenting, via at least one output device 160, warning message (324 or 336 of FIG. 3) of a risk of sharing sensitive content 202 to an unknown or untrusted caller.

In one or more embodiments, electronic device 100 includes at least one input device 151 and at least one output device 160 communicatively coupled to processor 112. Memory 120 further includes: (i) sensitive content 202; and (ii) authentication data 204 associated with user 102 of electronic device 100. Processor 112 is further configured to cause electronic device 100 to identify, as the access trigger, a user input to initiate the access to sensitive content 202. Processor 112 is further configured to cause electronic device 100 to perform the secure content intervention by generating and presenting a prompt for entry of a user authentication input to enable accessing sensitive content 202. Processor 112 is further configured to cause electronic device 100 to: compare a received user authentication input to stored authentication data 204; and enable access to sensitive content 202 in response to the received user authentication input matching stored authentication data 204. In one or more particular embodiments, stored authentication data 204 is at least one from among a group of: (i) a personal identification number (PIN); (ii) a stored private gesture; (iii) a text code; and (iv) biometric verification data. In one or more particular embodiments, in response to each subsequent user input to initiate access to sensitive content 202 during the call session, processor 112 is further configured to cause electronic device 100 to perform a corresponding subsequent secure content intervention.

In one or more embodiments, electronic device 100 includes artificial intelligence (AI) engine 115 trained for natural language processing and that: monitors communication exchanged occurring during the call session; detects requests for and/or or references to sensitive content 202 stored on electronic device 100 by one of user 102 of electronic device 100 or second user 103 (FIG. 1A) of at least one second electronic device 104 during the call session; and triggers presentation of warning (324 or 336 of FIG. 3) of potential sharing of sensitive data with an unknown or untrusted caller and initiates performance of the sensitive content intervention.

In one or more embodiments, electronic device 100 includes image capturing device 152 communicatively coupled to processor 112. Processor 112 is further configured to cause electronic device 112 to perform the sensitive content intervention by blocking capturing and transmitting of sensitive content 202 (e.g., audio, image, video) during the call session. In one or more embodiments, sensitive content 202 is at least one of a group comprising personal data, biometric data, financial data, and account access data.

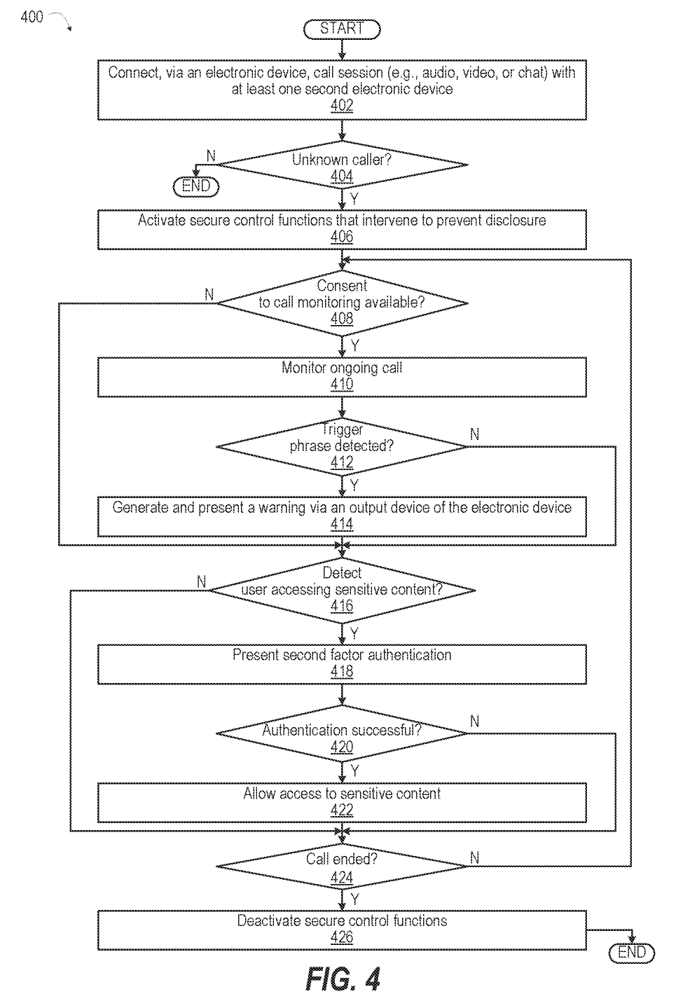

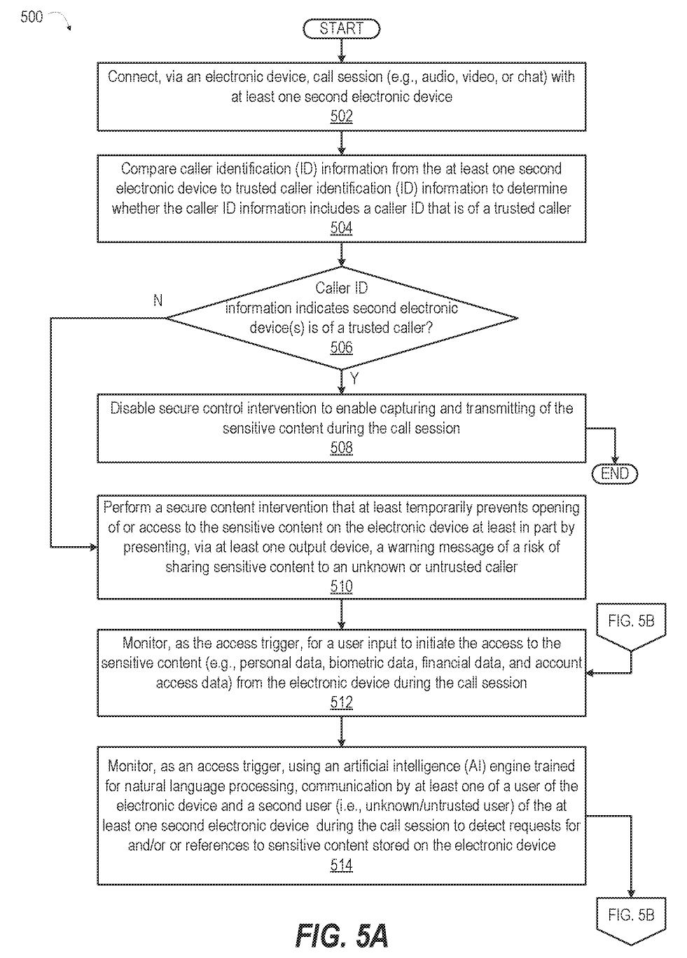

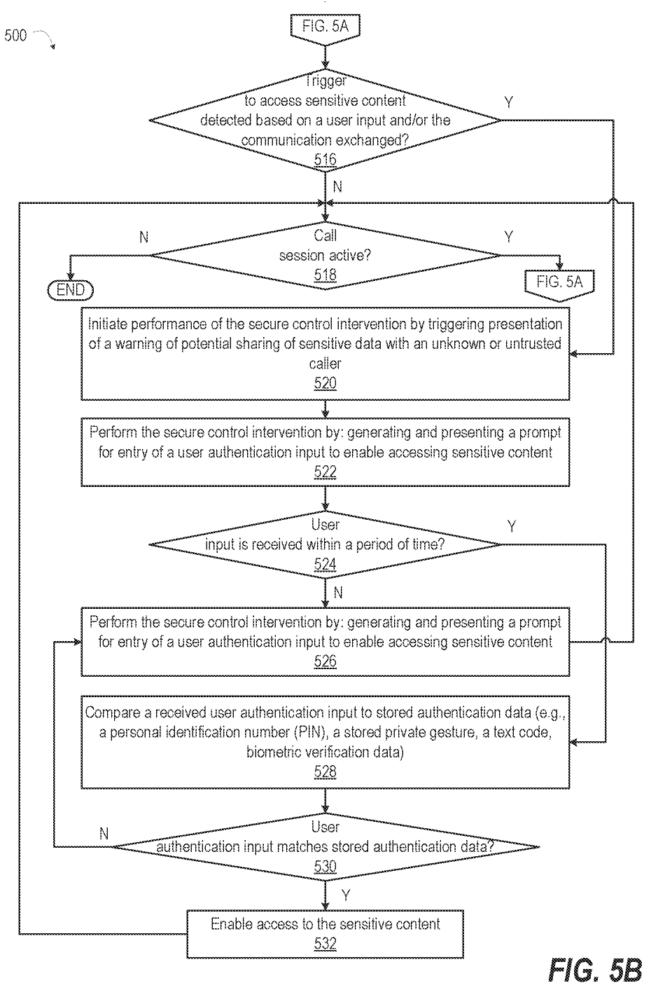

FIG. 4 is a flow diagram presenting computer-implemented method 400 for detecting and intervening in disclosure of sensitive/secure information to an unknown/untrusted participant in a call session with the electronic device. FIGS. 5A – 5B (collectively “FIG. 5”) is a flow diagram presenting computer-implemented method 500 augmenting method 400 (FIG. 4) with a plurality of techniques for intervening during a communication call between the electronic device and a second electronic device that is unknown or untrusted. The descriptions of method 400 (FIG. 4) and method 500 (FIG. 5) are provided with general reference to the specific components illustrated within the preceding FIGS. 1A – 1B and 2 – 3. Specific components referenced in method 400 (FIG. 4) and method 500 (FIG. 5) may be identical or similar to components of the same name used in describing preceding FIGS. 1A – 1B and 2 – 3. In one or more embodiments, controller 110 (FIG. 1A) configures electronic device 100 (FIGS. 1A – 1B) or a similar computing device to provide the described functionality of method 400 (FIG. 4) and method 500 (FIG. 5).

With reference to FIG. 4, method 400 includes connecting, via an electronic device, a call session (e.g., audio, video, or chat) with at least one second electronic device (block 402). Method 400 includes determining whether the at least one second electronic device is associated with an unknown caller (decision block 404). In response to determining that the at least one second electronic device is not associated with an unknown caller, method 400 ends. In response to determining that the at least one second electronic device is associated with an unknown caller, method 400 includes activating secure control functions of electronic device that intervene to prevent disclosure of sensitive content (block 406). Method 400 includes determining whether consent to call monitoring is available (decision block 408). In response to determining that consent to call monitoring is available, method 400 includes monitoring the ongoing call (block 410). Method 400 includes determining whether a trigger phrase is detected (decision block 412). In response to determining that a trigger phrase is detected, method 400 includes generating and presenting a warning to a user via an output device of the electronic device (block 414). In response determining that consent to call monitoring is not available in decision block 408, or in response to determining that a trigger phrase was not detected in decision block 412, or after warning the user in block 414, method 400 includes determining whether the user accessing sensitive content is detected (decision block 416). In response to determining that the user accessing sensitive content is detected, method 400 includes presenting a second factor authentication (block 418). Method 400 includes determining whether authentication is successful (decision block 420). In response to determining that authentication is successful, method 400 includes allowing access the sensitive content (block 422). In response to determining that the user did not access sensitive content in decision block 416, or in response to determining that authentication was not successful in decision block 420, or after allowing access in block 422, method 400 includes determining whether the call is ended (decision block 424). In response to determining that the call is not ended, method 400 returns to block 408. In response to determining that the call is ended, method 400 includes deactivating secure control functions of electronic device that intervene to prevent disclosure of sensitive content (block 426). Then method 400 ends.

With reference to FIG. 5A, method 500 includes connecting, via an electronic device, call session (e.g., audio, video, or chat) with at least one second electronic device (block 502). Method 500 includes comparing caller identification (ID) information from the at least one second electronic device to trusted caller identification (ID) information to determine whether the caller ID information includes a caller ID that is of a trusted caller (block 504). Method 500 includes determining whether the caller ID information indicates that the at least one second electronic device is of a trusted caller (decision block 506). In response to determining that the caller ID information indicates that the at least one second electronic device is of a trusted caller, method 500 includes disabling secure content intervention to enable capturing and transmitting of the sensitive content during the call session (block 508). Then method 500 ends.

In response to determining that the caller ID information does not indicate that the at least one second electronic device is of a trusted caller, method 500 includes performing a sensitive content intervention that at least temporarily prevents opening of or access to the sensitive content on the electronic device at least in part by presenting, via at least one output device, a warning message of a risk of sharing sensitive content to an unknown or untrusted caller (block 510). Method 500 includes monitoring, as the access trigger, for a user input to initiate the access to the sensitive content (e.g., personal data, biometric data, financial data, and account access data) from the electronic device during the call session (block 512). Method 500 includes monitoring, as an access trigger, using an artificial intelligence (AI) engine trained for natural language processing, communication by at least one of a user of the electronic device and a second user (i.e., unknown/untrusted user) of the at least one second electronic device during the call session to detect requests for and/or or references to sensitive content stored on the electronic device (block 514). Then method 500 proceeds to block 516 of FIG. 5B.

With reference to FIG. 5B, method 500 includes determining whether a trigger to access sensitive content is detected based on a user input and/or the communication exchanged (decision block 516). In response to determining that a trigger to access sensitive content is not detected, method 500 includes determining whether the call session is active (decision block 518). In response to determining that the call session is not active, method 500 ends. In response to determining that the call session is active, method 500 returns to block 512 of FIG. 5A. In response to determining that a trigger to access sensitive content is detected in decision block 516, method 500 includes initiating performance of the secure content intervention by triggering presentation of a warning of potential sharing of sensitive data with an unknown or untrusted caller (block 520). Method 500 includes performing additional aspects of the sensitive content intervention by: generating and presenting a prompt for entry of a user authentication input to enable accessing sensitive content (block 522). Method 500 includes determining whether a user input is received within a period of time (decision block 524). In response to determining that a user input is not received within the period of time, method 500 includes performing the sensitive content intervention by blocking capturing and transmitting of the sensitive content during the call session (block 526). Then method 500 returns to decision block 518.

In response to determining that a user input is received within the period of time in decision block 524, method 500 includes comparing a received user authentication input to stored authentication data (e.g., a personal identification number (PIN), a stored private gesture, a text code, biometric verification data) (block 528). Method 500 includes determining whether the received user authentication input matches the stored authentication data (decision block 530). In response to determining that the received user authentication input does not match the stored authentication data, method 500 returns to block 526. In response to determining that the received user authentication input matches the stored authentication data, method 500 includes enabling access to the sensitive content (block 532). Then method 500 returns to block 518 in order to respond to each subsequent user input to initiate access to the sensitive content during the call session.

According to aspects of the present disclosure, electronic device 100 (FIG. 1A), method 400 (FIG. 4) and method 500 (FIG. 5), and computer program product, such as RSD 145 (FIG. 1A), provide techniques for intervening during a call session to prevent disclosure of sensitive content by a user of electronic device 100 (FIG. 1A) to an unknown or untrusted caller. The intervention may include a warning message presented via an output device. The intervention may include a required second factor authentication before access or transmission of sensitive content is allowed. The electronic device may anticipate the impending disclosure by detecting trigger statements made by the unknown/untrusted caller that could prompt the user to respond with sensitive content known to the user. The electronic device may store and allow use of sensitive content with intervention triggered during the call by attempts by the user to access/use the sensitive content that risks disclosure to the unknown/untrusted caller.

Aspects of the present innovation are described above with reference to flowchart illustrations and/or block diagrams of methods, apparatus (systems) and computer program products according to embodiments of the innovation. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

As will be appreciated by one skilled in the art, embodiments of the present innovation may be embodied as a system, device, and/or method. Accordingly, embodiments of the present innovation may take the form of an entirely hardware embodiment or an embodiment combining software and hardware embodiments that may all generally be referred to herein as a “circuit,” “module” or “system.”

While the innovation has been described with reference to exemplary embodiments, it will be understood by those skilled in the art that various changes may be made, and equivalents may be substituted for elements thereof without departing from the scope of the innovation. In addition, many modifications may be made to adapt a particular system, device, or component thereof to the teachings of the innovation without departing from the essential scope thereof. Therefore, it is intended that the innovation not be limited to the particular embodiments disclosed for carrying out this innovation, but that the innovation will include all embodiments falling within the scope of the appended claims. Moreover, the use of the terms first, second, etc., do not denote any order or importance, but rather the terms first, second, etc. are used to distinguish one element from another.

The terminology used herein is for the purpose of describing particular embodiments only and is not intended to be limiting of the innovation. As used herein, the singular forms "a", "an" and "the" are intended to include the plural forms as well, unless the context clearly indicates otherwise. It will be further understood that the terms "comprise" and/or "comprising," when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present innovation has been presented for purposes of illustration and description but is not intended to be exhaustive or limited to the innovation in the form disclosed. Many modifications and variations will be apparent to those of ordinary skill in the art without departing from the scope and spirit of the innovation. The embodiments were chosen and described in order to best explain the principles of the innovation and the practical application, and to enable others of ordinary skill in the art to understand the innovation for various embodiments with various modifications as are suited to the particular use contemplated.

What is claimed is:

1. An electronic device comprising:
a memory comprising a content security during untrusted communication (CSDUC) module;
a communications subsystem that links the electronic device to a communication network; and
a processor communicatively coupled to the memory and the communications subsystem, and which is configured to cause the electronic device to:
connect, via the communications subsystem, a call session with at least one second electronic device;
monitor for a trigger to access sensitive content from the electronic device during the call session; and
in response to detecting the trigger to access sensitive content:
compare caller identification (ID) information from the at least one second electronic device to trusted caller ID information to determine whether the caller ID information comprises a caller ID that is of a trusted caller; and
in response to determining that the caller ID information does not indicate that the at least one second electronic device is of a trusted caller,
perform a sensitive content intervention that at least temporarily prevents opening of or access to the sensitive content on the electronic device.

2. The electronic device of claim 1, further comprising at least one output device communicatively coupled to the processor, and wherein the processor is further configured to cause the electronic device to:
perform the sensitive content intervention by presenting, via the at least one output device, a warning message of a risk of sharing sensitive content to an unknown or untrusted caller.

3. The electronic device of claim 1, further comprising:
at least one input device and at least one output device communicatively coupled to the processor;
wherein the memory further comprises: (i) the sensitive content; and (ii) authentication data associated with a user of the electronic device; and
wherein the processor is further configured to cause the electronic device to:
identify, as the access trigger, a user input to initiate the access to the sensitive content; and
perform the sensitive content intervention by: generating and presenting a prompt for entry of a user authentication input to enable accessing the sensitive content; comparing a received user authentication input to stored authentication data; and enabling access to the sensitive content in response to the received user authentication input matching the stored authentication data.

4. The electronic device of claim 3, wherein the stored authentication data comprises at least one from among a group of: (i) a personal identification number (PIN); (ii) a stored private gesture; (iii) a text code; and (iv) biometric verification data.

5. The electronic device of claim 3, wherein the processor is further configured to cause the electronic device to:
in response to each subsequent user input to initiate access to the sensitive content during the call session, perform a corresponding subsequent secure content intervention.

6. The electronic device of claim 1, further comprising an artificial intelligence (AI) engine trained for natural language processing and that: monitors communication exchanged occurring during the call session; detects requests for and/or or references to sensitive content stored on the electronic device by one of a user of the electronic device or a second user of the at least one second electronic device during the call session; and triggers presentation of a warning of potential sharing of sensitive data with an unknown or untrusted caller and initiates performance of the sensitive content intervention.

7. The electronic device of claim 1, further comprising an image capturing device communicatively coupled to the processor and wherein the processor is further configured to cause the electronic device to:
perform the sensitive content intervention by blocking capturing and transmitting of the sensitive content during the call session.

8. The electronic device of claim 1, wherein the sensitive content is at least one of a group comprising personal data, biometric data, financial data, and account access data.

9. A method comprising:
connecting, via an electronic device, a call session with at least one second electronic device;
monitoring for a trigger to access sensitive content from the electronic device during the call session; and
in response to detecting the trigger to access sensitive content:
comparing caller identification (ID) information from the at least one second electronic device to trusted caller ID information to determine whether the caller ID information comprises a caller ID that is of a trusted caller; and
in response to determining that the caller ID information does not indicate that the at least one second electronic device is of a trusted caller, performing a sensitive content intervention that at least temporarily prevents opening of or access to the sensitive content on the electronic device.

10. The method of claim 9, further comprising performing the sensitive content intervention by presenting, via at least one output device, a warning message of a risk of sharing sensitive content to an unknown or untrusted caller.

11. The method of claim 9, further comprising:
identifying, as the access trigger, a user input to initiate the access to the sensitive content; and
performing the sensitive content intervention by: generating and presenting a prompt for entry of a user authentication input to enable accessing sensitive content; comparing a received user authentication input to stored authentication data; and enabling access to the sensitive content in response to the received user authentication input matching the stored authentication data.

12. The method of claim 11, wherein the stored authentication data comprises at least one from among a group of: (i) a personal identification number (PIN); (ii) a stored private gesture; (iii) a text code; and (iv) biometric verification data.

13. The method of claim 11, further comprising:
in response to each subsequent user input to initiate access to the sensitive content during the call session, performing a corresponding subsequent secure content intervention.

14. The method of claim 9, further comprising using an artificial intelligence (AI) engine trained for natural language processing and that: monitors communication exchanged occurring during the call session; detects requests for and/or or references to sensitive content stored on the electronic device by one of a user of the electronic device or a second user of the at least one second electronic device during the call session; and triggers presentation of a warning of potential sharing of sensitive data with an unknown or untrusted caller and initiates performance of the sensitive content intervention.

15. The method of claim 9, further comprising performing the sensitive content intervention by blocking capturing and transmitting of the sensitive content during the call session.

16. The method of claim 9, wherein the sensitive content is at least one of a group comprising personal data, biometric data, financial data, and account access data.

17. A computer program product comprising:
a computer readable storage device; and
program code on the computer readable storage device that when executed by a processor associated with an electronic device, the program code is configured to cause the electronic device to provide functionality of:
connecting, via the electronic device, a call session with at least one second electronic device;
monitoring for a trigger to access sensitive content from the electronic device during the call session; and
in response to detecting the trigger to access sensitive content:
comparing caller identification (ID) information from the at least one second electronic device to trusted caller ID information to determine whether the caller ID information comprises a caller ID that is of a trusted caller; and
in response to determining that the caller ID information does not indicate that the at least one second electronic device is of a trusted caller,
performing a sensitive content intervention that at least temporarily prevents opening of or access to the sensitive content on the electronic device.

18. The computer program product of claim 17, wherein the program code is configured to cause the electronic device to provide functionality of:
performing the sensitive content intervention by presenting, via at least one output device, a warning message of a risk of sharing sensitive content to an unknown or untrusted caller and by blocking capturing and transmitting of the sensitive content during the call session, wherein the sensitive content is at least one of a group comprising personal data, biometric data, financial data, and account access data.

19. The computer program product of claim 17, wherein the program code is configured to cause the electronic device to provide functionality of:
identifying, as the access trigger, a user input to initiate the access to the sensitive content;
performing the sensitive content intervention by: generating and presenting a prompt for entry of a user authentication input to enable accessing sensitive content; comparing a received user authentication input to stored authentication data; and enabling access to the sensitive content in response to the received user authentication input matching the stored authentication data, wherein the stored authentication data comprises at least one from among a group of: (i) a personal identification number (PIN); (ii) a stored private gesture; (iii) a text code; and (iv) biometric verification data; and
in response to each subsequent user input to initiate access to the sensitive content during the call session, performing a corresponding subsequent secure content intervention.

20. The computer program product of claim 17, wherein the program code is configured to cause the electronic device to provide functionality of:
using an artificial intelligence (AI) engine trained for natural language processing and that: monitors communication exchanged occurring during the call session; detects requests for and/or or references to sensitive content stored on the electronic device by one of a user of the electronic device or a second user of the at least one second electronic device during the call session; and triggers presentation of a warning of potential sharing of sensitive data with an unknown or untrusted caller and initiates performance of the sensitive content intervention.
